(19) United States
(12) Patent Application Publication
(10) Pub. No.: US 2024/0187526 A1
(43) Pub. Date: Jun. 6, 2024

(54) Video Voicemail Application

(71) Applicant: Philip Michael Scopes, Chicago, IL (US)

(72) Inventor: Philip Michael Scopes, Chicago, IL (US)

(21) Appl. No.: 18/529,957

(22) Filed: Dec. 5, 2023

Related U.S. Application Data
(60) Provisional application No. 63/386,130, filed on Dec. 5, 2022.

(51) Int. Cl. H04M 3/53; H04L 9/40; H04W 4/14

(52) U.S. Cl. CPC H04M 3/5315; H04L 63/0861; H04W 4/14; H04L 2463/082

(57) ABSTRACT

A system and method for storing, recording, and perusing video messages as a messaging service. The opt-in method manages the processes of creating and replaying the video through an application interface available to registered users. Callers are able to witness greetings left by boxholders and, in turn, record their own messages or follow up through other communication channels. Boxholders are able to leave one or more greetings, potentially designating greetings to specific callers, as well as managing the messages left by their callers. Video files can also be uploaded as greetings or messages through an alternative interface.

### FIELD OF THE INVENTION

The present invention relates generally to applications for the transmittal and receipt of voicemails. Specifically, the present invention relates to an application to allow for the transmittal, receipt, and playback of voicemails including video components.

### BACKGROUND OF THE INVENTION

Communication is a powerful tool, and modern communications systems allow for a great deal of access to convenient and instant communication. Systems such as phone calls and video calls allow for instant remote communications. However, recipients of such communications are not always available to receive the communication. Existing systems allow for audio voicemails to be stored in the event a recipient is unable to receive an audio message. However, audio recordings are limited, and lack many crucial elements of communication, including the ability of the recipient to read body language and gestures.

For the forgoing reasons, there exists a need for a convenient and efficient system to transmit and store video voicemail messages. The present invention aims to solve this problem through the creation of a video voicemail application. The video voicemail application creates a system to store, transmit, and search for voicemails having a video component on a user's electronic device, such as a smartphone, tablet, or computer. A user can sign up for a user account that may be associated with their business or company. The user may set up video voicemail boxes that are associated with their user account. Each video voicemail box may be associated with one or more video greeting messages. Each video voicemail box may be set up as either a tree-style box, allowing multiple greeting messages to be stored on the same voicemail box, or a single-greeting voicemail box, having only a singular greeting message. A user who wishes to make a call may search for the recipient mailbox by a variety of means, such as keyword searching or phone number searching. A caller may select the greeting to view from the selected voicemail box, view the associated greeting, then leave their video message for the recipient. Each voicemail box may further have an associated farewell message that plays after the caller leaves the video voicemail message.

### BRIEF DESCRIPTION OF THE DRAWINGS

FIG. 1 is a flow diagram showing an overview of a system for an embodiment the present invention.

FIG. 2 is a diagram highlighting the interface options found through the application for an embodiment of the present invention.

FIG. 3 is a flow diagram demonstrating the process steps for an embodiment of the present invention.

### DETAIL DESCRIPTIONS OF THE INVENTION

All illustrations of the drawings are for the purpose of describing selected versions of the present invention and are not intended to limit the scope of the present invention.

The present invention comprises a caller application to play video greetings and record messages to send to a boxholder, a boxholder application to record video greetings and manage voicemail recordings, a user account, a database, and a file uploading website.

A user account is associated with a username, a password, a calling number, a company name, one or more voicemail boxes, and a list of contacts. All user account information is stored server-side on the database. The database communicates with the caller application and the boxholder application through sending and receiving packets of information over a network, such as the use of TCP or IP packets to transmit information. Each voicemail box may either be either a single-greeting box or a tree-style box. The tree-style box comprises a main greeting video and one or more sub-greeting videos, while the single-greeting box comprises only one greeting video. Unless stated otherwise, all components which transfer data should be presumed to transfer data in a similar manner through sending and receiving packets of information over a network.

The caller application and boxholder application further comprise a login prompt. The login prompt comprises a username prompt and a password prompt. A user may login using the username and password associated with their user account to gain access to the application. The login information is verified by the server, and if the verification is successful, the user will be able to access the caller and boxholder application. The use of two-factor authentication to verify and secure user accounts is contemplated. When the user successfully logs in to their user account in the caller application, they are presented with a list of available boxes to call. The list of available boxes to call is searchable by any metric, such as the company name, calling number, or keyword. The use of weblinks and QR codes to access a box is further contemplated.

The caller application further comprises a list of available boxes to call. For the caller application, each voicemail box in the list of available boxes further comprises a plurality of buttons. The plurality of buttons comprises a greeting button, an email button, a call button, or a short message service (SMS) button. When the call button is pressed, the caller application will play back a video greeting associated with the video voicemail box. For some embodiments, where the video voicemail box is a tree-style box, the user will be further prompted to select one greeting to play from the multiple greeting videos associated with the tree-style box. The user may interrupt a greeting to immediately skip to recording a message or return to the previous screen to select from the list of available boxes. Once a video voicemail box is selected, the user is prompted to either record a message, review a previously recorded message, or delete a previously recorded message.

In one embodiment, once the user has either sent or cancelled the message, the app will play a farewell message. The farewell message may prompt a user to register for their own voicemail box or display any other relevant text or message to the user. Once the farewell message plays, the user is returned to the list of available boxes.

The boxholder application comprises three tabs: a video message retrieval tab, and video greeting recording tab, and a settings tab.

The video message retrieval tab performs a variety of functions, comprising a means to show incoming video messages, a means for playing back video messages, a means for deleting messages, and a prompt to initiate a return call to the caller. In one embodiment, the use of text transcription for a message is contemplated, which will interpret and display a text transcription from the audio of a video voicemail alongside the video voicemail message.

The video greeting recording tab comprises a means for setting up video voicemail boxes. The means for setting up video voicemail boxes further comprises the option to set up the voicemail box as an announcement only box, a single-greeting box, or a tree-style box. An announcement only box can only play back a greeting message, it is unable to store or receive video messages from a caller. The means for setting up video voicemail boxes further comprises a means to record a video greeting and associate the video greeting with a video voicemail box. If the video voicemail box is a tree-style box, the user is prompted to select whether the recording will be associated with the main greeting for the box, or any number of the one or more subgreetings associated with the video voicemail box. If selecting a subgreeting, the user may be prompted with a means to select the specific subgreeting, such as a scroll wheel to select a subgreeting. There is further provided a means to play greetings from each box, record greetings for each video voicemail box, and delete greetings from each video voicemail box.

The settings tab further comprises a plurality of settings, user profile information, subscription information, and preferences. The subscription information further comprises a means for collecting billing information and billing a user for the service. The settings may include the ability to switch on or off the ability to receive calls, SMS, video messages, and emails. The user profile information may display the user's profile data for review, such as the phone number and company name associated with the user account. The preferences may include any settings that effect the user's experience of the video voicemail application.

The file uploading website further comprises a login page. The login page may use either the same or separate credentials from the boxholder and caller applications. The file uploading website further comprises a selection box. The selection box may include a means to select a file, a location selection describing where to send the file, a file select dialog box, and a submit button. A user is first prompted to enter the login information associated with a user account on the login page. The login information is verified by the server, and if the verification is successful, the user will be able to access the file uploading website. Once logged in, the user may choose to upload a video file using the selection box, and to send that video file to a designated video voicemail box. For example, a user may login, select video file “video1.mp4” from their computer using the selection box, select “video voicemail box_tree_sub4” as the destination box, and then press the submit button to upload the selected video file to the selected sub-greeting of the selected tree-style box.

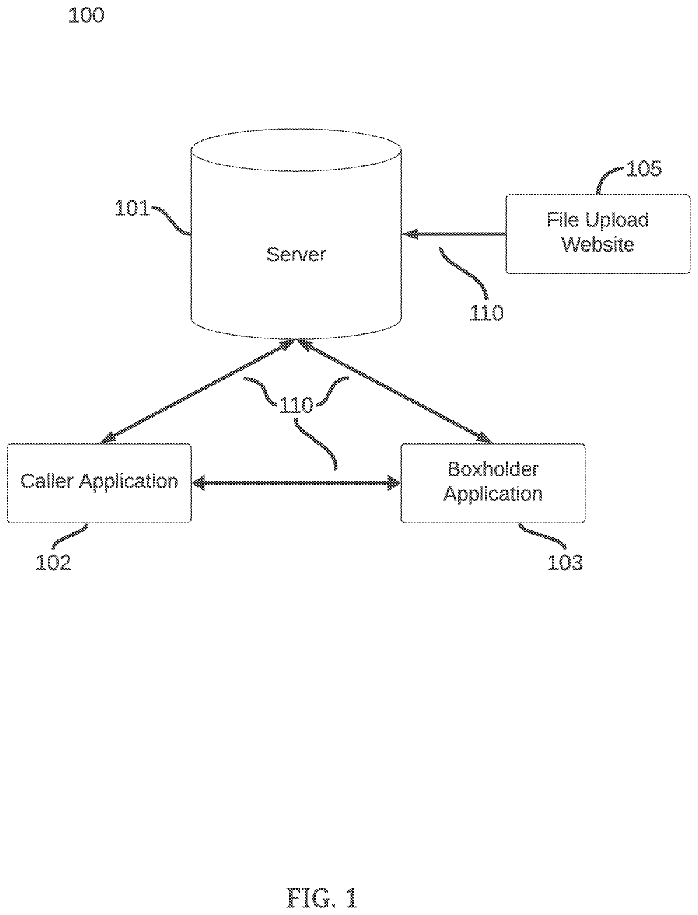

FIG. 1 provides an overview for some embodiments of the present invention, implemented as a system 100. The system comprises a server 101 which serves to store and organize the video messages. The server 101 is accessed through a network 110 by designated functional pathways. A caller application 102 accesses the server when hearing a greeting or leaving a message. A boxholder application 103 accesses the server to record greetings, view their received video messages, or otherwise manage their profile and inbox. This embodiment also allows an option for direct communication between a caller and a boxholder, though the application (102 or 103) interface. Another means of interfacing with the system is to directly upload video messages through a dedicated website 105. Some embodiments may alternately or additionally integrate the upload website 105 functionality into the application (102 and/or 104) interfaces.

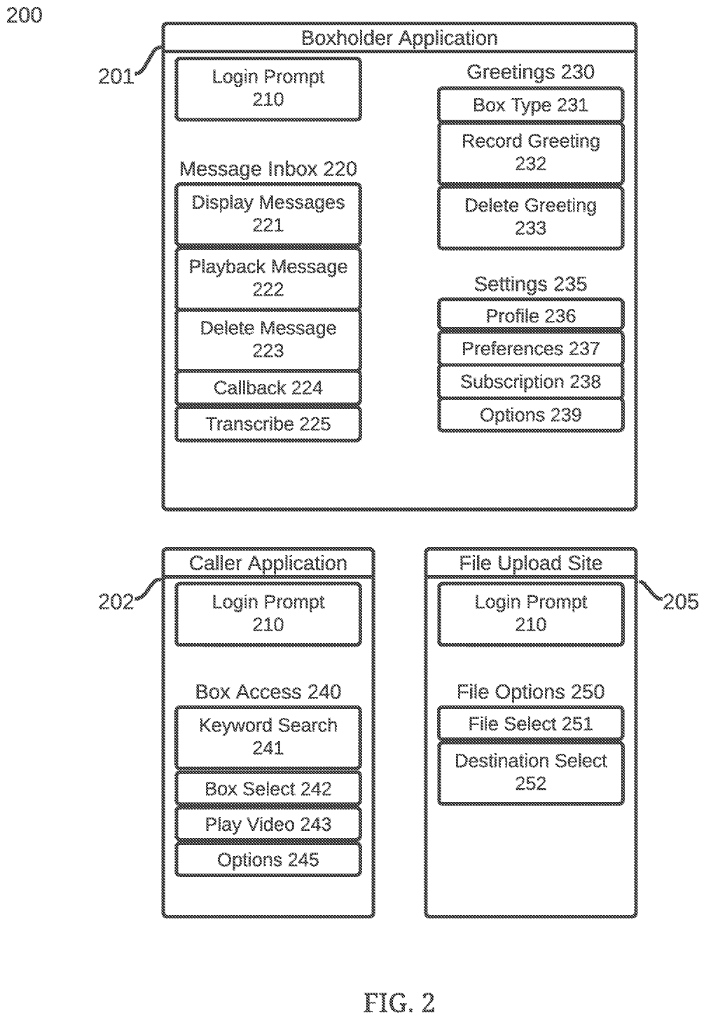

FIG. 2 demonstrates the options available to the application interfaces 200 for an embodiment of the invention. The boxholder application 201, caller application 202, and file upload site 205 each require a login process 210 to identify the user before accessing the selected interface options (200). Most embodiments of the boxholder application 201 rely on three sets of interface options: Inbox Management 220, Greeting Management 230, and General Settings 235. The message inbox 220 allows the boxholder to display their available messages (221) and select them for playback (222). They may also choose management options, such as deleting the message (223) or calling back the message leaver (224). Some embodiments may also consider management options like message forwarding, archival, or clipping. This embodiment also considers the option of providing an audio-to-text capture function (225) so they may read all or part of the message. Some embodiments would also consider text-to-audio playback for optional text communications considered in those embodiments. The greetings management option 230 allows a boxholder to set their box to be of single or multiple greetings type 231. Further, a boxholder may record greetings (232) or delete existing greetings (233). Some embodiments may allow selection of uploaded files as greetings or provide video editing tools to manage their greetings. The settings option 235 allows a boxholder to manage their box and system settings. The ability to define their profile 236 is important for identification by callers. A number of preferences 237 may be available from a system manager, such as two-factor identification or blocking certain callers. The boxholder may also be able to manage their subscription 238 to the service through this interface. Other management options 239 may also be included, such as the ability to turn off direct in-application communications with callers and other boxholders.

A caller (202) that logs in (210) will generally be given the opportunity to determine with which box they're trying to communicate through the box access interface 240. In addition to browsing a list, this embodiment provides a keyword search 241 to case this determination. Other embodiments may utilize alternate search techniques while some may even have the selection incorporated into the calling process. Box selection 242 will typically involve the playing of a greeting 243 from the boxholder. A caller is then presented with a number of options 245, typically including the recording of their video message and reviewing that video to ensure it is the desired message to leave. Other options may include direct communication with the box holder through a direct call to an alternate means of reaching them or in-application text communications. Loging in (210) to the file upload site (205) would allow a user to choose from among certain video file options 250. Choosing a file from their device (251) and then determining which message box or greeting as its destination (252) would be the typical pattern in this use case.

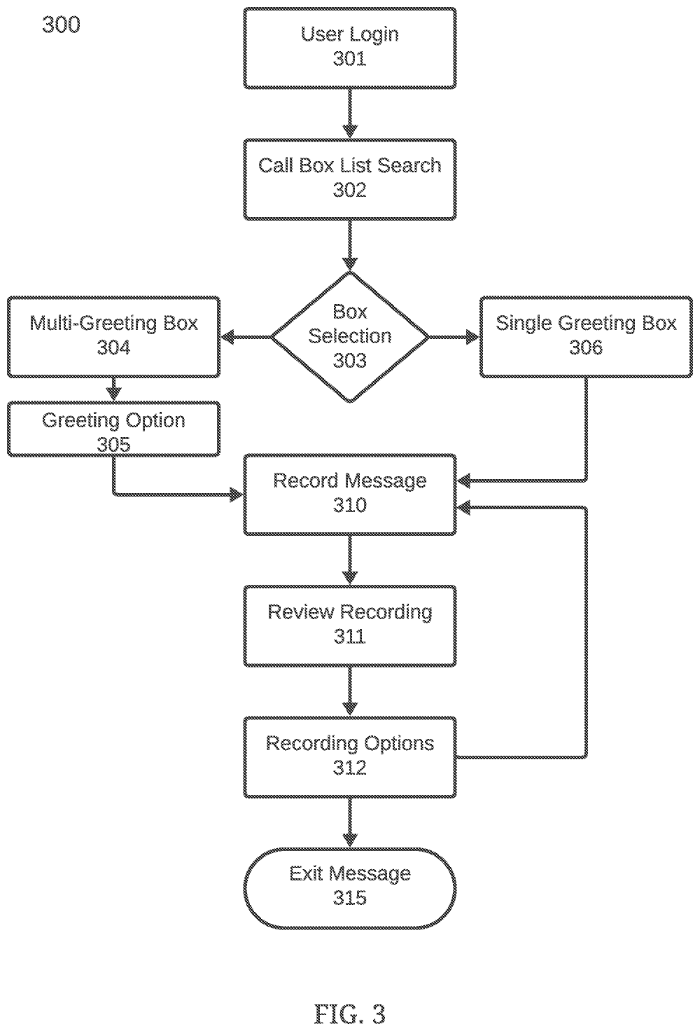

FIG. 3 demonstrates the a typical flow pattern for the a caller's user experience (300). The caller would begin by logging in (301) and proceed to determine which call box they're accessing (302). Selecting (303) a box may result in a single greeting box (306) or a multiple greeting box (304), which would further require them to determine which of the multiple greetings they're going to hear (305). In either case, after hearing the recorded greeting, they would then have the option to record their own message for the boxholder (310). Upon reviewing their recording (311), they are provided with an interface to determine whether they wish to leave that message (312) or return to re-record their message (310). In this embodiment, a farewell message is played as the caller then leaves the interface (315).

Although the invention has been explained in relation to its preferred embodiment, it is to be understood that many other possible modifications and variations can be made without departing from the spirit and scope of the invention.

1. A method comprising:
Receiving a message request from a caller;
Providing the caller with an interface by a server over a network;
Providing a selection of one or more call boxes from which to choose through the interface;
Choosing a call box with which to interact through the interface;
Playing a greeting from the chosen call box;
Recording a video message through the interface;
Storing the recorded video message on a non-transitory storage device;
Exiting the interface and network communications.

2. The method of claim 1, wherein the non-transitory storage device is located on the server.

3. The method of claim 1, wherein the greeting of the chosen call box is selected through the interface from a list of available greetings provided by the interface.

4. The method of claim 1, further comprising the following steps between providing the caller with an interface and providing a selection of one or more call boxes:
Prompting the caller to provide login credentials through the interface;
Verifying the login credentials of the caller by the server;

5. The method of claim 4, wherein the login credentials are verified using two-factor authentication.

6. The method of claim 4, wherein the login credentials are verified using biometric technology.

7. The method of claim 1, wherein choosing the call box with which to interact allows an interactable search to choose a call box.

8. The method of claim 7, wherein the interactable search is a keyword search.

9. The method of claim 1, wherein the caller may interrupt the greeting playback of the chosen call box.

10. The method of claim 1, wherein the interface allows a caller the options to review and/or record a replacement video message before Storing the recorded video message.

11. The method of claim 1, wherein the interface provides an option to send a text-based message in lieu of recording a video message.

12. The method of claim 11, wherein the text-based message is an SMS message.

13. The method of claim 11, wherein the text-based message is an email message.

14. The method of claim 1, which further comprises:
The caller receiving a message through the interface while exiting the interface.

15. The method of claim 1, wherein the interface provides an option to upload a video file in lieu of recording a video message.

16. A method comprising:
Receiving an access request from a boxholder;
Providing the boxholder with an interface by a server over a network;
Prompting the boxholder to provide login credentials through the interface;
Verifying the login credentials of the boxholder by the server;
Providing a selection of one or more management options from which to choose through the interface;
Choosing a management option through the interface;
Providing a selection of one or more actions associated with the chosen management option;
Selecting an action from the one or more provided actions;
Performing the provided action;
Providing the option to continue selecting actions;
Exiting the interface and network.

17. The method of claim 16, wherein one of the management options provided is a message retrieval option and one of the actions associated with the message retrieval option is to playback a stored video message.

18. The method of claim 17, wherein one of the actions associated with the message retrieval option is to delete a stored video message.

19. The method of claim 16, wherein one of the management options provided is a message recording option and one of the actions associated with the message recording option is to record a video message as a greeting.

20. The method of claim 16, wherein one of the management options provided is a settings option and one or more of the actions associated with the settings option are to modify stored information associated with the boxholder's account.
